(19) United States
(12) Patent Application Publication
(10) Pub. No.: US 2012/0073102 A1
(43) Pub. Date: Mar. 29, 2012

(54) Hightower's Big Truck Brake Drum Handler

(76) Inventor: Jeffery Elijah Hightower, Elkton, KY (US)

(21) Appl. No.: 12/893,897

(22) Filed: Sep. 29, 2010

(51) Int. Cl. B25B 27/14

(52) U.S. Cl. 29/283

(57) ABSTRACT

A device for providing manual removal and installation of brake drums on tractor trailers and can be adapted to use on other vehicles. The handler is used to manually lift the brake drum either taking off the wheel assembly or putting it back on. It provides easier handling and more safely manipulation of heavy brake drum.

### FIELD OF THE INVENTION

This invention related a device adapted for manually removal and installation of brake drums on vehicles and transporting

### BACKGROUND OF THE INVENTION

It is very difficult to handle brake drums on semi-trucks and trailers in order to service or replace the drums or to perform service on the brakes and associated parts. The most common way to remove and install brake drums has been by using hands to remove them. This is difficult and is prone to injury

Brake drums, such as used on large trucks can weigh as much as 120 pounds each. They are very awkward to grasp and handle.

Vertical access to the brake drum often is difficult or impossible because of the overhead obstructions. Devices with wheels many times are not practical because they are hard to operate on uneven or rough ground which many times is the case.

The present invention is directed to solving these problems by providing a very efficient simple to operate and cost effective handler which can be used by an operator. The handler is easily operated with both hands and can be used in any environment.

### BRIEF SUMMARY OF THE INVENTION

The object of this invention is to provide a simple, efficient and cost-efficient, handler for facilitation manually transporting, removal and installation of brake drums on vehicles.

This handling invention weighs about six pounds with only one moving part. It is a 2½ inch wide steel band rolled into a circle with a clamping device at the top to firmly hold the brake drum in place. It has handles on both sides to provide a firm grip for the operator. Tighten band on drum to install or remove from the wheel assemble. This is a simple procedure that takes just seconds.

Drawing 1: Hightower's big truck brake drum handler

Drawing 2: Hightower's big truck brake drum handler on brake drum

Drawing 3: Parts and make up of Hightower's big truck brake drum handler

### DESCRIPTION OF PARTS AND MAKE UP

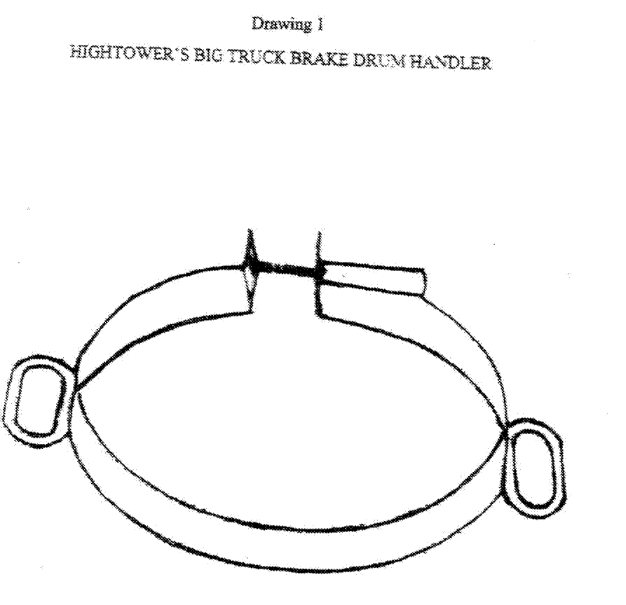

FIG. 1. Mild steel band 58″ long, 2½″ wide, ⅛″ thick with ¾″× 7/16″ punched hole on each end.

FIG. 2. Roll band into a circle.

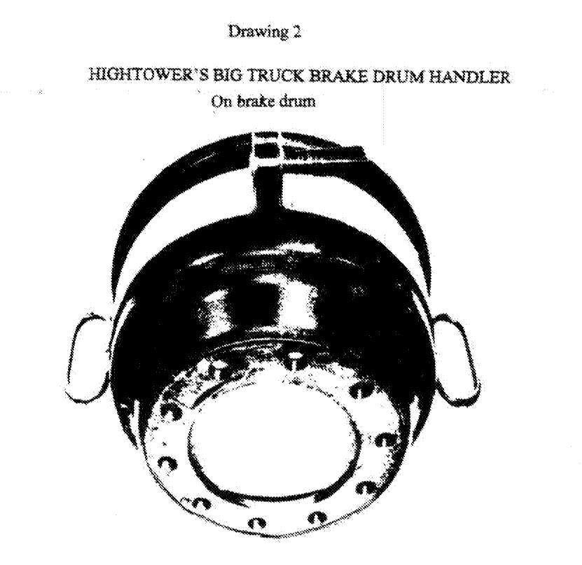

FIG. 3. Bend 1¾″ 90 degree on each end.

FIG. 4. Two 12″ long×½″ round rods.

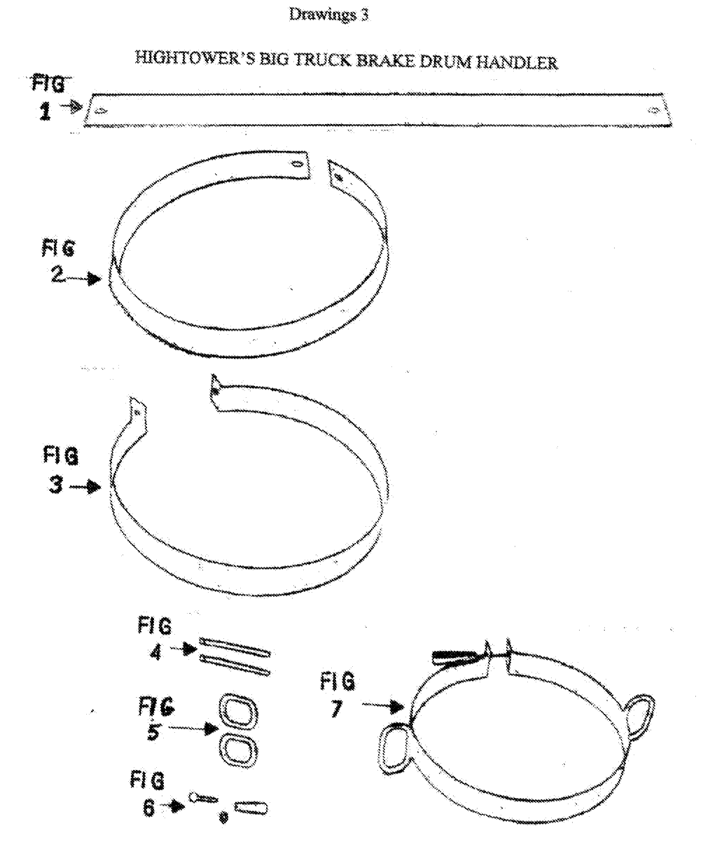

FIG. 5. Bend round rods into ovals for handles.

FIG. 6. Bought 1 carriage bolt 3½″ long ⅜″×16, 1 washer, 1 knob.

FIG. 7. Weld 1 FIG. 5 oval on each side of band, put carriage bolt through punched holes, then put washer and tightening knob on carriage bolt.

What is claimed:

1. A device for facilitation removal and installation of brake drums on vehicles, comprising: A metal band with a clamping device with handles for manually lifting brake drums to take off or put on wheel assembly.
